(19) United States
(12) Patent Application Publication
(10) Pub. No.: US 2025/0389947 A1
(43) Pub. Date: Dec. 25, 2025

(54) Inscription Loupe

(71) Applicant: Shenzhen Dikai Industrial Co., Ltd, Shenzhen City (CN)

(72) Inventors: XIULING ZHU, Shenzhen (CN); XIANNIAN ZHU, Shenzhen (CN)

(73) Assignee: Shenzhen Dikai Industrial Co., Ltd, Shenzhen City (CN)

(21) Appl. No.: 18/975,817

(22) Filed: Dec. 10, 2024

(30) Foreign Application Priority Data
Jun. 24, 2024 (CN) 202410818587.0

(51) Int. Cl. G02B 25/00; G01N 21/87

(52) U.S. Cl. CPC G02B 25/005; G01N 21/87

(57) ABSTRACT

A bare diamond waist code mirror includes a seat body, an observation mechanism, a first focusing mechanism, a second focusing mechanism, and a diamond clip. A clamping mechanism is installed in the seat body, the observation mechanism includes a gearbox and a magnifying lens assembly, the gearbox is movably installed onto the seat body and is finely adjusted forward and backward through the first focusing mechanism, the magnifying lens assembly is movably installed on the gearbox and is finely adjusted vertically through the second focusing mechanism, the diamond clip is used for clipping a gem and is rotatably fixed on the clamping mechanism, the diamond clip is rotated, and the magnifying lens assembly is focused for observing a code of the gem. The diamond clip is rotated and adjusted by manual operation, and the code can be found by rotation of the gem and two-dimensional fine adjustment.

### TECHNICAL FIELD

The present invention relates to the technical field of microscopes, and specifically relates to a bare diamond waist code mirror, which can achieve eye-level and magnified observation of a waist code of a bare diamond or gem.

### BACKGROUND ART

Bare diamonds are loose diamonds that have been cut-machined and polished but not inlaid, and the bare diamonds are clear, transparent, and beautiful and are loved by people. Generally, the bare diamonds are printed with GIA codes or marks on waists through laser.

Diamonds with GIA certificates or certificates of various jewelry are provided with GIA codes that are engraved on the diamonds or gems. Alternatively, after a bare diamond is appraised, an appraisal agency generally engraves a laser code on the diamond, and the laser code corresponds to the GIA certificate. Having a laser code indicates that the bare diamond is genuine. Generally, diamonds will have the GIA codes engraved on waist crest lines. In the prior art, for a bare diamond that is not inlaid, the code can only be observed with a handheld magnifying lens or a desktop microscope.

The handheld magnifying lens in the prior art does not have a fine-adjustment structure, which is not convenient for observing a bare diamond or gem in a small particle form. The existing handheld magnifying lens is mainly composed of a lens, a lens fixing frame, and a handle. The handle is connected to the lens frame, and the handle and the lens are in a horizontally parallel state. When the magnifying lens is held with a hand to observe a small bare diamond or gem, on the one hand, it is not convenient to adjust an observation position of the bare diamond or gem; and on the other hand, the lens is tilted, and distances of various viewpoints between the lens and an observed object are different, which is not conducive to observation of the bare diamond or gem.

However, for a desktop microscope of the prior art, the design of an object stage is not convenient for loading a bare diamond or gem, and a top-down observation manner is not suitable for observing a bare diamond or gem. In addition, the fine-adjustment structure of a lens assembly is not convenient for three-dimensional observation of a bare diamond or gem.

### SUMMARY OF THE INVENTION

Based on this, in order to solve the above-mentioned problems in the traditional technology, the present invention proposes a bare diamond waist code mirror which is of an eye-level observation design, and proposes upward and downward, front and back and own circumferential multi-dimensional position fine adjustment and focusing of a bare diamond or gem by means of a rotatable diamond clip and two sets of focusing mechanisms, so that a code of the bare diamond or gem can be observed more conveniently and more clearly.

The present invention relates to a bare diamond waist code mirror, including a scat body, an observation mechanism, a first focusing mechanism, a second focusing mechanism, and a diamond clip. A clamping cavity is formed in the seat body, a clamping mechanism is installed in the clamping cavity, the observation mechanism includes a gearbox and a magnifying lens assembly, the gearbox is movably installed onto the seat body and is finely adjusted forward and backward through the first focusing mechanism for displacement, the magnifying lens assembly is movably installed onto the gearbox and is finely adjusted vertically through the second focusing mechanism for displacement, the diamond clip is used for clipping the diamond or gem and is rotatably fixed on the clamping mechanism, the diamond clip is rotated, and the magnifying lens assembly is focused for observing the code of the diamond or gem.

In a structural design of the seat body, the clamping cavity includes an upper clamping cavity and a lower clamping cavity, the seat body includes a first outer shell, a second outer shell, a first structural inner shell, and a second structural inner shell, and the first outer shell, the second outer shell, and the first structural inner shell close in at an upper part of the seat body to form the upper clamping cavity; and the first outer shell, the second outer shell, and the second structural inner shell close in at a bottom of the seat body to form the lower clamping cavity.

The clamping mechanism is divided into an upper part and a lower part and can stably clamp the diamond clip, the clamping mechanism includes a first clamp and a second clamp that are used for holding the diamond clip, the first clamp is fixed on the first structural inner shell in the upper clamping cavity, and the second clamp is fixed on the second structural inner shell in the lower clamping cavity.

Notches are provided on back parts of the first outer shell and the second outer shell to form an entrance-exit window of the gearbox; and after middle parts of the first outer shell and the second outer shell are both concavely assembled, an operating space for the diamond clip is formed.

The observation mechanism is of an eye-level observation design, the magnifying lens assembly includes a lens barrel, a magnifying lens is arranged in the lens barrel, an edge of the lens barrel is sleeved with a silica gel sleeve, a second rack plate is arranged on the lens barrel in an extending manner, a tail end of the second rack plate is provided with at least one buckle that can be buckled inside the seat body, and the magnifying lens is a 20-30× magnifying lens.

The gearbox includes a base plate, a top wall, a first side wall, a second side wall, a bottom wall, and a first rack plate formed on the base plate, installation through holes are provided on the base plate, an opening used for allowing the second rack plate to pass through is provided on the top wall, and a pair of installation holes and a pair of installation grooves are provided on the first side wall and the second side wall.

In a forward and backward displacement adjustment structure, the first focusing mechanism includes a first connecting rod, the first connecting rod penetrates the pair of installation grooves of the gearbox, the first connecting rod is sleeved with first transmission teeth, two ends of the first connecting rod are respectively provided with a first focal length knob, and the first transmission teeth are meshed with the first rack plate to be used for finely adjusting forward and backward displacement of the gearbox and the magnifying lens assembly.

A pair of guideposts are arranged in the seat body, each guidepost passes through the corresponding installation through hole on the base plate, so that the gearbox can slide at front and rear positions along the guideposts, the top of the seat body is provided with an upper cover, and the upper cover is recessed to form a yielding groove that is in communication with the upper clamping cavity.

In an upward and downward displacement adjustment structure, the second focusing mechanism includes a second connecting rod that penetrates the pair of installation holes of the gearbox, the second connecting rod is sleeved with second transmission teeth, two ends of the second connecting rod are respectively provided with a second focal length knob, and the second transmission teeth are meshed with the second rack plate to be used for finely adjusting upward and downward displacement of the magnifying lens assembly.

Preferably, the diamond clip includes a rod body, a push rod, and a claw, the rod body is hollow and is internally provided with a return spring, one end of the return spring is pressed against the push rod, the other end is pressed against the claw, the push rod is pressed, and the claw is expanded under an action of the return spring to clip the diamond or gem.

The bare diamond waist code mirror of the present invention adopts an eye-level observation design, allows the bare diamond or gem to be observed without bending down and lowering the head, combines an ergonomic structural design of the seat body, and is convenient to operate and comfortable to use. The bare diamond waist code mirror combines two sets of focusing mechanisms and own rotation of the diamond clip in the seat body. Specifically, the first focusing mechanism is used for achieving fine adjustment of forward and backward displacement of the gearbox together with the magnifying lens assembly, and also provides fine adjustment of focusing of a magnifying lens; the second focusing mechanism is used for achieving fine adjustment of upward and downward displacement of the magnifying lens assembly, and also provides fine adjustment of upward and downward height and focusing of the magnifying lens; and the rotatable diamond clip in the seat body is used for achieving circumferential fine adjustment in an own circumferential direction and focusing of the bare diamond or gem thercon. Thus, multi-dimension position fine adjustment in forward and backward, upward and downward, and bare diamond's own circumferential directions are achieved while focusing, so that the code of the bare diamond or gem can be more stably, more conveniently, and more clearly observed.

In the bare diamond waist code mirror of the present invention, the diamond or gem is clamped at the top of the diamond clip, can easily enter and exit from the clamping cavity at the front end of the seat body, and is rotatably fixed on the clamping mechanism, and the code of the bare diamond is found in conjunction with rotation position adjustment of the diamond clip on the basis of a two-dimensional fine adjustment design, not only making the operation and use convenient, but also making it easier and faster to find the code or a mark.

In the bare diamond waist code mirror of the present invention, the clamping cavity in the seat body includes an upper clamping cavity and a lower clamping cavity, the middle part of the seat body is concave to form an operating space used for rotating the diamond clip, a space for fixing the diamond clip and rotating the diamond clip is reserved between the upper clamping cavity and the lower clamping cavity, and at the same time, the clamping cavity is also convenient for manually loading or pulling out the diamond clip. After being clipped by the diamond clip, the diamond or gem can be placed directly in the seat body without any obstacle. The code or mark of the diamond or gem is only on one of engraved faces of diamond waist facets. In this operating space, the diamond clip is directly rotated with fingers, and a focus length is adjusted through the first focusing mechanism and the second focusing mechanism while rotating to find the code or mark on the engraved face.

In addition, in the bare diamond waist code mirror of the present invention, the magnifying lens assembly includes a lens barrel, and an edge of the lens barrel is sleeved with a silica gel sleeve. In an eye-level observation design, it is needed to be very close to the magnifying lens assembly for observation. The silica gel sleeve is arranged on the lens barrel, and a user first touches the soft silica gel sleeve during observation, so that the comfort of observation and use can be increased, and hard contact with eyes is prevented.

### BRIEF DESCRIPTION OF THE DRAWINGS

In order to explain the technical solution in an embodiment of the present invention or the prior art more clearly, the accompanying drawings that need to be used in the description of the embodiment or the prior art will be briefly introduced below. Apparently, the accompanying drawings described below are merely some embodiments of the present invention, and other drawings may further be obtained by those of ordinary skill in the art according to these accompanying drawings without any inventive work.

Among them:

FIG. 1 is a schematic three-dimensional structural diagram of a bare diamond waist code mirror of this embodiment, with a gearbox that is rotated out;

FIG. 2 is a schematic side face structural diagram of the bare diamond waist code mirror of this embodiment, with the gearbox that is rotated in;

FIG. 3 is a three-dimensional structural diagram of the bare diamond waist code mirror of this embodiment, with no diamond clip inserted;

FIG. 4 is a three-dimensional structural diagram of the bare diamond waist code mirror of this embodiment, with the diamond clip loaded;

FIG. 5 is a three-dimensional exploded mechanism diagram of the bare diamond waist code mirror of this embodiment;

FIG. 6 is an enlarged structural diagram of a box body of the gearbox of the bare diamond waist code mirror of this embodiment.

### DETAILED DESCRIPTION OF EMBODIMENTS

The technical solutions in the embodiments of the present invention will be clearly and completely described below in conjunction with the accompanying drawings in the embodiments of the present invention, and it is obvious that the described embodiments are only some of the embodiments of the present invention, rather than all of the embodiments. Based on the embodiments in the present invention, all other embodiments obtained by those of ordinary skill in the art without any inventive work fall within the scope of protection of the present invention.

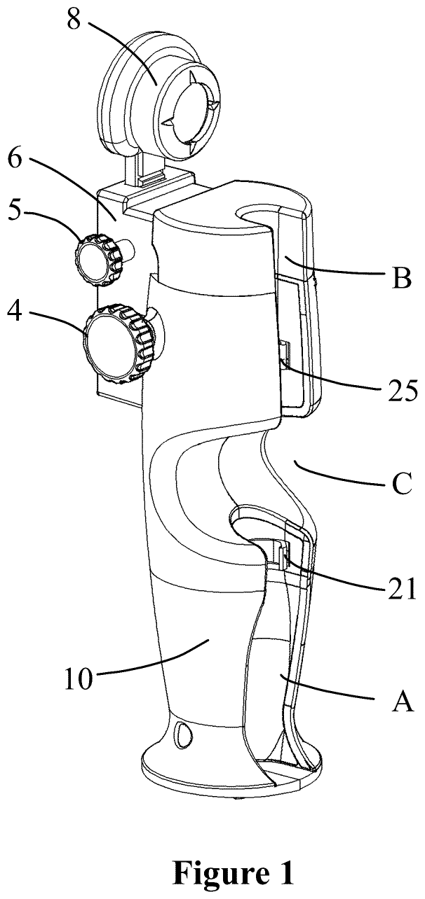

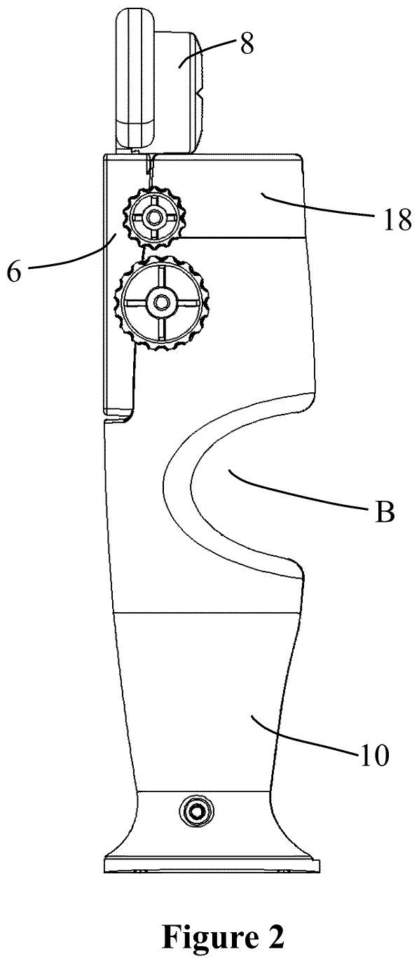

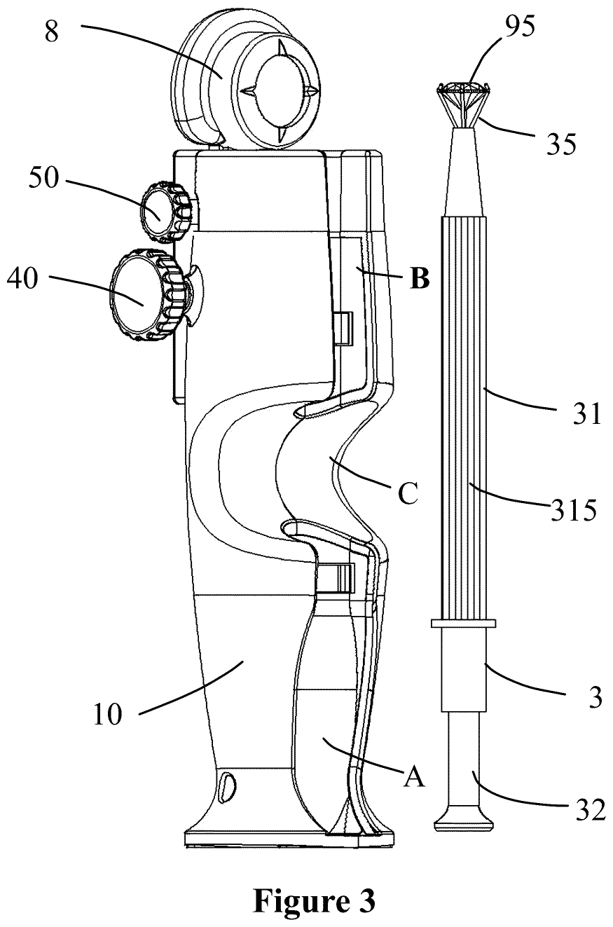

As shown in FIG. 1, FIG. 2, and FIG. 3, a bare diamond waist code mirror of this embodiment includes a seat body 10, an observation mechanism, a first focusing mechanism 4, a second focusing mechanism 5, and a diamond clip 3.

In general, clamping cavities (A, B) are formed in the seat body 10, and a clamping mechanism is installed in the clamping cavities. The observation mechanism includes a gearbox 6 and a magnifying lens assembly 8 that enables eye-level observation.

The gearbox 6 is movably installed onto the back part of the seat body 10 in a front-back direction, and achieves forward and backward fine adjustment for displacement and focusing through a gear in a box body meshed with the first focusing mechanism 4. The magnifying lens assembly 8 is provided with a second rack plate 812, is thus installed onto the gearbox 6 in an upward and downward moving manner through the second rack plate 812 extending into the box body, and achieves vertical fine adjustment of displacement and focusing through a gear of the second rack plate 812 meshed with the second focusing mechanism 5. The diamond clip 3 clips a diamond or gem 95, and is rotatably fixed on the clamping mechanism (21, 25), and the diamond clip 3 is rotated to achieve circumferential fine adjustment in an own circumferential direction and focusing of the bare diamond or gem 95 thereon. Through fine adjustment of displacement in the above three dimensions and focusing, the magnifying lens assembly 8 is focused for observing the code of the diamond or gem 95.

Specific embodiments are introduced as follows:

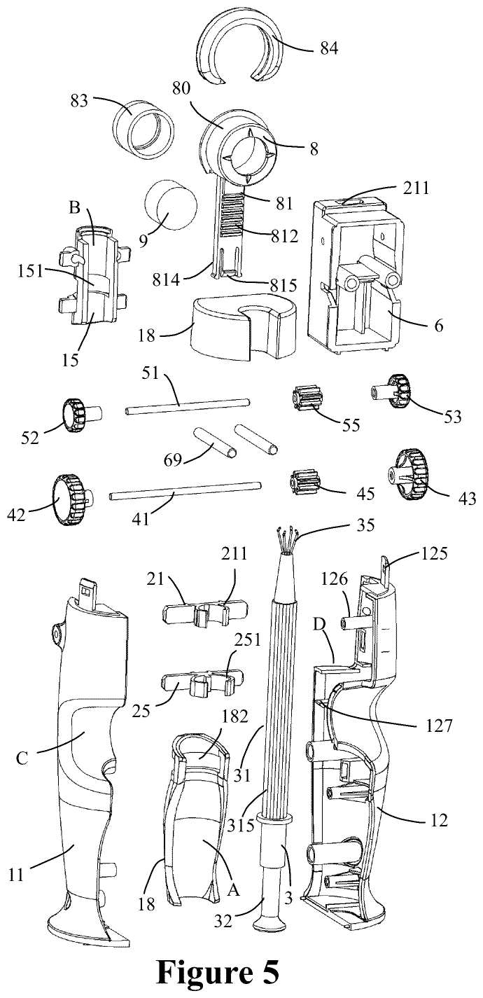

Referring to FIG. 5 together, the seat body 10 includes a first outer shell 11, a second outer shell 12, a first structural inner shell 15, and a second structural inner shell 18. The first outer shell 11 and the second outer shell 12 close in to form a seat body outer shell. The first outer shell 11, the second outer shell 12, and the first structural inner shell 15 close in at the upper part of the seat body to form the upper clamping cavity B; and the first outer shell 11, the second outer shell 12, and the second structural inner shell 18 close in at the bottom of the seat body 10 to form the lower clamping cavity A. That is, the clamping cavity includes the upper clamping cavity A and the lower clamping cavity B.

Notches are provided on the back parts of the first outer shell 11 and the second outer shell 12 to form an entrance-exit window D of the gearbox 6. After the middle parts of the first outer shell 11 and the second outer shell 12 are both concavely assembled, an operating space C that is used for operating and rotating the diamond clip with a hand is formed. With the upper clamping cavity A and the lower clamping cavity B in the seat body 10, the middle part of the seat body 10 is concave to form the operating space C. Viewed from bottom to top, the upper clamping cavity A, the operating space C, and the lower clamping cavity B are in communication to be used for allowing the diamond clip 3 to pass through and be surrounded.

The top of the seat body 10 is provided with an upper cover 18, and the upper cover 18 is recessed to form a yielding groove 185 that is in communication with the upper clamping cavity B.

A gap width allowing the diamond clip 3 to be fixed and capable of rotating is reserved between the upper clamping cavity B and the lower clamping cavity A. At the same time, through the arrangement of the operating space C, a user can manually load or pull out the diamond clip 3 conveniently.

The bare diamond waist code mirror of this embodiment is of an eye-level observation design. The magnifying lens assembly 8 includes a lens barrel 80, a magnifying lens 9 is arranged in the lens barrel 80, and an edge of the lens barrel 80 is sleeved with a silica gel sleeve 84. In the eye-level observation design, it is needed to be very close to the magnifying lens assembly 8 for observation. By arranging the silica gel sleeve 84 on the lens barrel 80, the user first touches the soft silica gel sleeve 84 during observation, which prevents hard contact with eyes while improving the comfort of observation and use.

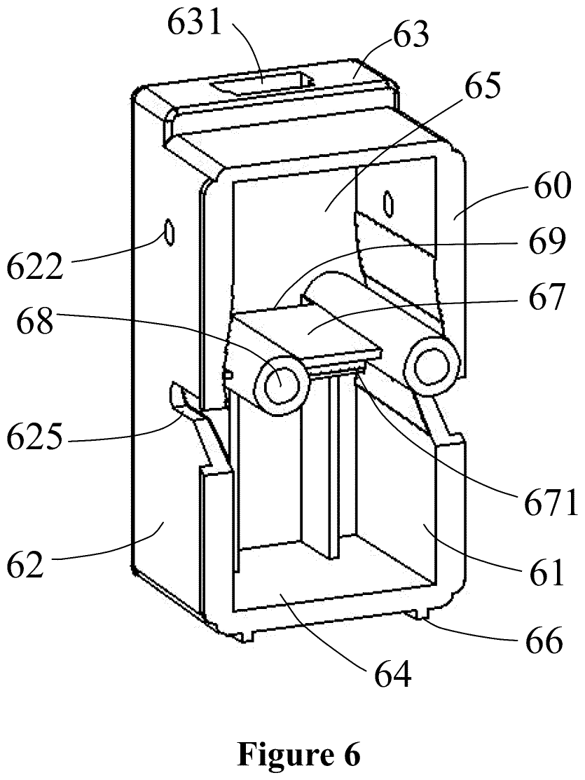

In order to achieve displacement adjustment of the magnifying lens assembly 8 in an upward and downward dimension, a second rack plate 81 is arranged on the lens barrel 80 in an extending manner. The tail end of the second rack plate 81 is provided with at least one buckle that can be buckled inside the gearbox 6, such as a middle buckle 815 and a buckle groove 69 provided in the gearbox 6 as shown in FIG. 5 and FIG. 6, and a pair of side buckles can be added on two sides of the middle buckle 815 to strengthen a locking state of the magnifying lens assembly 8 when retracted. In FIG. 6, the middle buckle 815 and/or a side buckle 814 cooperate/cooperates with the buckle groove 69 provided in the gearbox 6, so that the magnifying lens assembly can be buckled more tightly when it is pressed down to the lowest position, thereby protecting the lens assembly from being influenced by shaking and vibration.

In this embodiment, the magnifying lens is a 20-30× magnifying lens.

Referring to FIG. 6, the gearbox 6 includes a base plate 65, a first side wall 61, a second side wall 62, a top wall 63, a bottom wall 64, and a first rack plate 67 formed on the base plate 65. The buckle groove 69 is formed between the bottom of the first rack plate 67 and the base plate 65.

The base plate 65, on two sides of the first rack plate 67, is provided with installation through holes that are used for installing the gearbox 6 in a sliding manner, and the installation through holes are provided in post bodies, such as installation through holes 68. Two guideposts are arranged in the seat body 10, such as the first guidepost 19. Each guidepost in the seat body 10 passes through the corresponding installation through hole of the gearbox 6. For example, the first guidepost 19 passes through the installation through hole 68 in the gearbox 6, so that the gearbox 6 is installed in the seat body in a sliding manner and can slide in or slide out through an entrance-exit window D on the back part of the seat body 10.

An opening 631 used for allowing the second rack plate 81 of the magnifying lens assembly 8 to pass through is provided on the top wall 63. A pair of installation holes are provided on the first side wall 61 and the second side wall 62 for installing the second connecting rod 51 of the second focusing mechanism, such as installation holes 622 provided on the second side wall 62. A pair of installation grooves are provided on the first side wall 61 and the second side wall 62 for installing the first connecting rod 41 of the first focusing mechanism, such as installation grooves 625 provided on the second side wall 62.

The diamond clip 3 adopts a commonly used diamond clip on the market. The diamond clip 3 includes a rod body 31, a push rod 32, and a claw 35. The rod body 31 is hollow inside and is internally provided with a return spring (not shown in the figures). One end of the return spring is pressed against the push rod 32 at the bottom of the rod body 31, and the other end is pressed against the claw 35 that can be extended and contracted at the top of the rod body 31. The push rod 32 is pressed, and the claw 35 is expanded under an action of the return spring. The pressing of the push rod 32 is released, and the claw 35 contracts under an action of the return spring. When being expanded, the claw 35 can be used for clipping the diamond or gem. The rod body 31 is provided with a plurality of convex strips, such as convex strips 315 shown in FIG. 3.

The clamping mechanism includes a first clamp 21 and a second clamp 25 that are used for fixing and holding the diamond clip 3. The clamping mechanism installed in the clamping cavity respectively includes two parts, the second clamp 25 is fixed in the lower clamping cavity A, and the first clamp 21 is fixed in the upper clamping cavity B for stably clamping the rod body 31 of the diamond clip 3. The first clamp 21 includes a first clamp body and a first clamp piece 211. The second clamp 25 includes a second clamp body and a second clamp piece 251.

An upper installation groove 151 is provided on the first structural inner shell 15, the first clamp 21 is fixed on the first structural inner shell 15 in the upper clamping cavity B, and the first clamp piece 211 passes through the upper installation groove 151 to extend into the upper clamping cavity B. A lower installation groove 182 is provided on the second structural inner shell 18, the second clamp 25 is fixed on the second structural inner shell 18 in the lower clamping cavity A, and the second clamp piece 251 passes through the lower installation groove 182 to extend into the lower clamping cavity B.

When the diamond clip 3 is rotated, a first clamp piece 211 of the first clamp 21 and the second clamp piece 251 of the second clamp 25 both knock a plurality of convex strips arranged on the rod body 31 to be used for making a prompt sound for rotation of the bare diamond or gem 95 to know an approximate angle of rotation of the bare diamond or gem 95.

Referring to FIG. 1 and FIG. 5 together, in a forward and backward displacement adjustment and focusing structure, the first focusing mechanism 4 includes a first connecting rod 41, the first connecting rod 41 penetrates a pair of installation grooves (625) of the gearbox 6, first focal length knobs (42, 43) are respectively arranged at two ends of the penetrating first connecting rod 41, and the middle part is sleeved with first transmission teeth 45. The first transmission teeth 45 are meshed with a rack below the first rack plate 67 in the gearbox 6 for finely adjusting forward and backward displacement of the gearbox 6 and the magnifying lens assembly 8.

In an upward and downward displacement adjustment and focusing structure, the second focusing mechanism includes a second connecting rod 51, the middle part of the second connecting rod 51 is sleeved with second transmission teeth 55, the second connecting rod penetrates a pair of installation holes (622) on two side walls of the gearbox 6, and second focal length knob (52, 53) are respectively arranged at two ends extending out of the side walls of the gearbox 6. The second transmission teeth 55 are meshed with a rack on the second rack plate 81 of the magnifying lens assembly 8 to be used for finely adjusting displacement of the magnifying lens assembly 8 from an upward and downward dimension on the basis of forward and backward dimension displacement adjustment of the first focusing mechanism 4.

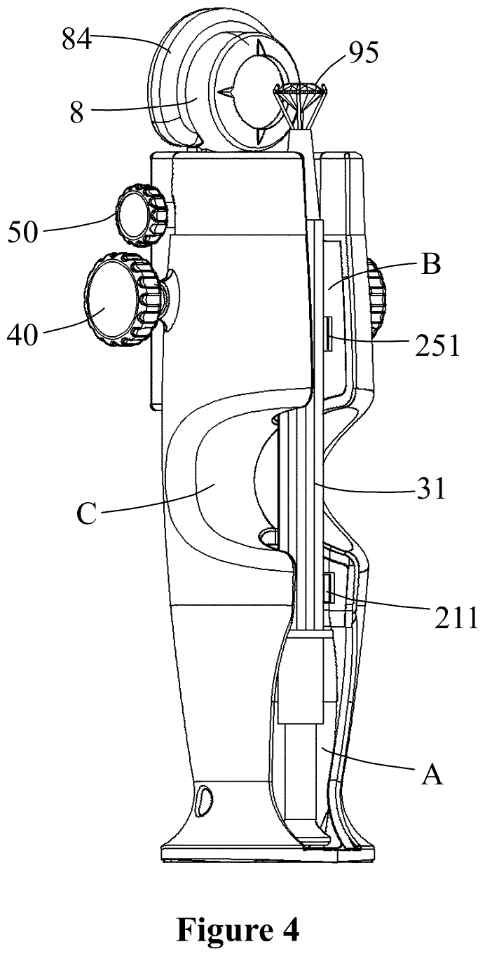

Referring to FIG. 3 and FIG. 4, when in use, after the diamond clip 3 clips the diamond or gem 95, the operating space C can avoid the hand, so that the diamond clip 3 can be directly placed and fixed in the upper clamping cavity A and the lower clamping cavity B of the seat body 10 without any obstacle, and a code or mark of the diamond or gem 95 is only on one of engraved faces of diamond waist facets. When in observation, the diamond clip 3 is directly rotated with fingers in the operating space C, and the position and focal length are adjusted through the first focusing mechanism 4 and the second focusing mechanism 5 while rotating to find the code or mark on the engraved face of the diamond or gem 95.

What is disclosed above is merely a preferred embodiment of the present invention, and certainly cannot be used for limiting the scope of the claims of the present invention. Therefore, equivalent changes made according to the claims of the present invention still fall within the scope covered by the present invention.

1. A bare diamond waist code mirror, comprising:
a seat body;
an observation mechanism;
a first focusing mechanism;
a second focusing mechanism; and
a diamond clip,
wherein:
a clamping cavity is formed in the seat body,
a clamping mechanism is installed in the clamping cavity,
the observation mechanism comprises a gearbox and a magnifying lens assembly,
the gearbox is movably installed onto the seat body and is finely adjusted forward and backward through the first focusing mechanism for displacement and focusing,
the magnifying lens assembly is movably installed onto the gearbox and is finely adjusted vertically through the second focusing mechanism for displacement and focusing,
the diamond clip is used for clipping a diamond or gem and is rotatably fixed on the clamping mechanism, the diamond clip being rotated, and
the magnifying lens assembly is focused for observing a code of the diamond or gem.

2. The bare diamond waist code mirror according to claim 1, wherein:
the clamping cavity comprises an upper clamping cavity and a lower clamping cavity,
the seat body comprises a first outer shell, a second outer shell, a first structural inner shell, and a second structural inner shell,
the first outer shell, the second outer shell, and the first structural inner shell close in at an upper part of the seat body to form the upper clamping cavity, and
the first outer shell, the second outer shell, and the second structural inner shell close in at a bottom of the seat body to form the lower clamping cavity.

3. The bare diamond waist code mirror according to claim 2, wherein:
the clamping mechanism comprises a first clamp and a second clamp which are used for holding the diamond clip,
the first clamp is fixed on the first structural inner shell in the upper clamping cavity, and
the second clamp is fixed on the second structural inner shell in the lower clamping cavity.

4. The bare diamond waist code mirror according to claim 2, wherein:
a plurality of notches are provided on back parts of the first outer shell and the second outer shell to form an entrance-exit window of the gearbox, and
after middle parts of the first outer shell and the second outer shell are both concavely assembled, an operating space for the diamond clip is formed.

5. The bare diamond waist code mirror according to claim 2, wherein:
the magnifying lens assembly comprises a lens barrel,
a magnifying lens is arranged in the lens barrel,
an edge of the lens barrel is sleeved with a silica gel sleeve,
a second rack plate is arranged on the lens barrel in an extending manner,
a tail end of the second rack plate is provided with at least one buckle that is configured to be buckled inside the seat body, and
the magnifying lens is a 20-30× magnifying lens.

6. The bare diamond waist code mirror according to claim 5, wherein:
the gearbox comprises a base plate, a top wall, a first side wall, a second side wall, a bottom wall, and a first rack plate formed on the base plate,
installation through a plurality of holes are provided on the base plate,
an opening used for allowing the second rack plate to pass through is provided on the top wall, and
a pair of installation holes and a pair of installation grooves are provided on the first side wall and the second side wall.

7. The bare diamond waist code mirror according to claim 6, wherein:
the first focusing mechanism comprises a first connecting rod,
the first connecting rod penetrates the pair of installation grooves of the gearbox,
the first connecting rod is sleeved with first transmission teeth,
two ends of the first connecting rod are respectively provided with a first focal length knob, and
the first transmission teeth are meshed with the first rack plate to be used for finely adjusting forward and backward displacement of the gearbox and the magnifying lens assembly.

8. The bare diamond waist code mirror according to claim 6, wherein:
a pair of guideposts are arranged in the seat body,
each guidepost passes through the corresponding installation through hole on the base plate allowing the gearbox to slide in front and back positions along the guideposts,
the top of the seat body is provided with an upper cover, and
the upper cover is recessed to form a yielding groove that is in communication with the upper clamping cavity.

9. The bare diamond waist code mirror according to claim 6, wherein:
the second focusing mechanism comprises a second connecting rod,
the second connecting rod penetrates the pair of installation holes of the gearbox,
the second connecting rod is sleeved with second transmission teeth,
two ends of the second connecting rod are respectively provided with a second focal length knob, and
the second transmission teeth are meshed with the second rack plate to be used for finely adjusting upward and downward displacement of the magnifying lens assembly.

10. A bare diamond waist code mirror, comprising:
a seat body;
an observation mechanism;
a first focusing mechanism;
a second focusing mechanism; and
a diamond clip,
wherein:
a clamping cavity is formed in the seat body,
a clamping mechanism is installed in the clamping cavity,
the observation mechanism comprises a gearbox and a magnifying lens assembly,
the gearbox is movably installed onto the seat body and is finely adjusted forward and backward through the first focusing mechanism for displacement and focusing,
the magnifying lens assembly is movably installed onto the gearbox and is finely adjusted vertically through the second focusing mechanism for displacement and focusing,
the diamond clip is used for clipping a diamond or gem and is rotatably fixed on the clamping mechanism, the diamond clip being rotated,
the magnifying lens assembly is focused for observing a code of the diamond or gem,
the diamond clip comprises a rod body, a push rod, and a claw,
the rod body is hollow and is internally provided with a return spring,
one end of the return spring is pressed against the push rod, the other end is pressed against the claw,
when the push rod is pressed, the claw is expanded under an action of the return spring to be used for clipping a diamond or gem, and
the rod body is provided with a plurality of convex strips used for making a rotation prompt sound.

11. The bare diamond waist code mirror according to claim 10, wherein:
the clamping cavity comprises an upper clamping cavity and a lower clamping cavity,
the seat body comprises a first outer shell, a second outer shell, a first structural inner shell, and a second structural inner shell,
the first outer shell, the second outer shell, and the first structural inner shell close in at an upper part of the seat body to form the upper clamping cavity, and
the first outer shell, the second outer shell, and the second structural inner shell close in at a bottom of the seat body to form the lower clamping cavity.

12. The bare diamond waist code mirror according to claim 11, wherein:
the clamping mechanism comprises a first clamp and a second clamp which are used for holding the diamond clip,
the first clamp is fixed on the first structural inner shell in the upper clamping cavity, and
the second clamp is fixed on the second structural inner shell in the lower clamping cavity.

13. The bare diamond waist code mirror according to claim 11, wherein:
a plurality of notches are provided on back parts of the first outer shell and the second outer shell to form an entrance-exit window of the gearbox, and
after middle parts of the first outer shell and the second outer shell are both concavely assembled, an operating space for the diamond clip is formed.

14. The bare diamond waist code mirror according to claim 11, wherein:
the magnifying lens assembly comprises a lens barrel,
a magnifying lens is arranged in the lens barrel,
an edge of the lens barrel is sleeved with a silica gel sleeve,
a second rack plate is arranged on the lens barrel in an extending manner,
a tail end of the second rack plate is provided with at least one buckle that is configured to be buckled inside the seat body, and
the magnifying lens is a 20-30× magnifying lens.

15. The bare diamond waist code mirror according to claim 14, wherein:
the gearbox comprises a base plate, a top wall, a first side wall, a second side wall, a bottom wall, and a first rack plate formed on the base plate,
installation through a plurality of holes are provided on the base plate,
an opening used for allowing the second rack plate to pass through is provided on the top wall, and
a pair of installation holes and a pair of installation grooves are provided on the first side wall and the second side wall.

16. The bare diamond waist code mirror according to claim 15, wherein:
the first focusing mechanism comprises a first connecting rod,
the first connecting rod penetrates the pair of installation grooves of the gearbox,
the first connecting rod is sleeved with first transmission teeth,
two ends of the first connecting rod are respectively provided with a first focal length knob, and
the first transmission teeth are meshed with the first rack plate to be used for finely adjusting forward and backward displacement of the gearbox and the magnifying lens assembly.

17. The bare diamond waist code mirror according to claim 15, wherein:
a pair of guideposts are arranged in the seat body,
each guidepost passes through the corresponding installation through hole on the base plate allowing the gearbox to slide in front and back positions along the guideposts,
the top of the seat body is provided with an upper cover, and
the upper cover is recessed to form a yielding groove that is in communication with the upper clamping cavity.

18. The bare diamond waist code mirror according to claim 15, wherein:
the second focusing mechanism comprises a second connecting rod,
the second connecting rod penetrates the pair of installation holes of the gearbox,
the second connecting rod is sleeved with second transmission teeth,
two ends of the second connecting rod are respectively provided with a second focal length knob, and
the second transmission teeth are meshed with the second rack plate to be used for finely adjusting upward and downward displacement of the magnifying lens assembly.
